(19) United States
(12) Patent Application Publication
(10) Pub. No.: US 2012/0294959 A1
(43) Pub. Date: Nov. 22, 2012

(54) BOTANICAL PESTICIDE FOR AGRICULTURE/HORTICULTURE CROPS

(75) Inventor: SUNDARESAN SUBRAMANYAN, Chennai (IN)

(73) Assignee: SREE RAMCIDES CHEMICALS PVT LTD, Chennai (IN)

(21) Appl. No.: 13/562,502

(22) Filed: Jul. 31, 2012

(30) Foreign Application Priority Data
Feb. 1, 2010 (IN) 240/CHE/2010
Jan. 31, 2011 (IN) PCT/IN2011/000067

(51) Int. Cl. A01N 65/20; A01P 7/02; A01N 65/38; A01P 7/04; A01N 65/40; A01N 65/48

(52) U.S. Cl. 424/756; 424/757

(57) ABSTRACT

The present invention relates to botanical pesticides for agricultural and horticultural crops and more specifically to a pesticidal composition comprising Adenanthera pavonina as the prime ingredient exhibiting synergism with other ingredients of the composition. The present invention further relates to the process of preparing eco friendly and environs safe botanical pesticide for controlling pests in agriculture and horticulture crops. Specifically the invention relates to botanical pesticides containing no level or substantially lower levels of chemicals. More specifically, the present invention provides for a process of preparing botanical pesticides that are relatively inexpensive to prevent pests in agriculture and horticulture crops.

### FIELD OF INVENTION

The present invention relates to pesticides and more specifically to botanical pesticides, exhibiting synergism for agricultural and horticultural crops. The present invention further relates to the process of preparing eco friendly and environs safe botanical pesticide for controlling pests in agriculture and horticulture crops. Specifically the invention relates to botanical pesticides containing no level or substantially lower levels of chemicals. More specifically, the present invention provides for a process of preparing botanical pesticides that are relatively inexpensive to prevent pests in agriculture and horticulture crops.

### DESCRIPTION OF PRIOR ART

Pests are annoying to humans for a myriad of reasons. A pesticide is any substance or mixture of substance intended for preventing, destroying, repelling or mitigating any pest. The losses caused by pests in agricultural environments include decreased crop yield, reduced crop quality, and increased harvesting costs.

Chemical pesticides are highly toxic and are very lethal not only to pests but anyone handling them, if not used with enough care. Conventional chemical pesticides exterminates pests in one go and are the quickest means of getting rid of these obnoxious creatures. However, it has become increasingly apparent that the widespread use of synthetic chemical pesticides has caused detrimental environmental effects that are harmful to humans and other animals. Moreover, some target pests have even shown an ability to develop immunity to many commonly used synthetic chemical pesticides.

On the other hand the demand for organic pesticides are high as they are farm-friendly and life enhancing, when compared to chemical pesticides. Organic pesticides, if used efficiently can be more beneficial and target specific. It should also be considered that the flowering plant varieties and tropical plants should be analyzed with self generated plant growth regulator to defend themselves for polysaccharides, poly amines and jasmonites etc. It is necessary to isolate plant growth regulators, defensive enzymes etc to defend cultivars as there is an abnormal increase in population and feeding NPK beyond the limit makes plants susceptible for pests and diseases.

As an alternative, botanical pesticides are of great interest because they are natural pesticides, and the toxicants derived from plants are safe to humans and the environment. Botanical pesticides are eco-friendly and environ safe, economic, target-specific and biodegradable. The combination of natural products, exhibiting synergistic effect would typically possess no direct toxic effect at the dosage employed, and such products will be able to substantially enhance the observed toxicity of a pesticide with which they are combined. Some of the invention existing in the prior art are mentioned below:

U.S. Pat. No. 7,807,201 relates to an antifungal agent for the prevention and treatment of aquatic fungal infections which does not speak about agriculture/horticulture as in the present invention.

U.S. Pat. No. 7,740,680 deals with an agricultural composition, which is a fertilizer composition, and not a pesticide.

US2008038383 relates to method for controlling pests applying a pesticidally-effective amount of a pesticidal composition comprising rosemary oil and wintergreen oil. US20070190094 describes a pesticidal composition comprising a pesticidally acceptable carrier and a pesticidally active ingredient comprising at least one isopropyl-containing compound.

CN 101336647 discloses a composite botanical pesticide prepared by mixing extracting solutions of angelica and castor which has comparatively higher toxicity, shortened insecticidal course and improved effect.

CN 101103733 deals with a plant pesticide emulsifiable solution and aqua which is made of calamus medicinal plants which solves the problem caused by the mass application of the chemical pesticides in the prevention and cure for pests of stored grain, sanitary insect pests, vegetable insect pests and flower insect pests.

CN 1810123 describes botanical pesticide that includes pesticide oil emulsion and pesticide oil aqua containing calamus extracting concentrate which is used for stored grains, household, vegetable and flower.

UA 14598 speaks about protecting and stimulating synergic composition for increasing productivity of farm crops contains at least one pesticide and at least one auxiliary ingredient with the properties of a growth stimulant and an adaptogen supplements it.

CN1430899 discloses an agricultural chemical without environmental pollution is prepared from emulsifier and 8 Chinese-medicinal materials.

None of the prior arts speak about a botanical pesticide which is exclusively for agriculture and horticulture crops and which is eco friendly. Accordingly, there is a great need for novel synergism exhibiting botanical pesticides containing no level or substantially lower levels of chemicals. In addition, there is a need for the process of preparing the same that address the problems described above, that are safe to humans and the environment and relatively inexpensive to prevent pests in agriculture and horticulture crops.

### OBJECT OF INVENTION

The primary object of the present invention is directed to provide synergic control of pests in agriculture/horticulture crops.

Most preferably another object of the present invention is to provide botanical pesticide that is eco friendly and environ safe for agricultural and horticultural crops.

It is another object of the present invention to provide botanical pesticide, wherein the product comprises of:
Adenanthera pavonina
Acorus calamus
Alpine galanga

It is another object of the present invention to provide botanical pesticide, wherein the prime ingredient Adenanthera pavonina exhibits synergism thereby helping the cultivars to protect agricultural and horticultural crops from pests.

It is another object of the present invention to provide botanical pesticide, wherein the plant based chemicals including alkaloids, terpenes, glycolides are not isolated and used to take advantage of the intrinsic balance of bio chemicals of plants.

It is yet another object of the present invention to provide botanical pesticide, wherein the product maintains herbal balance without going in for actives which would lead to the classification of product as chemical pesticide again.

It is yet another object of the present invention to provide botanical pesticide, wherein the product controls the target pests of cultivars that includes:
Aphids
Mites
Jassids
Fulgorids
Mealy bugs
Tea mites—scarlet, purple, yellow, green and red
Thrips
Lace wing bugs
Leaf miners

The details of the invention, its object and advantages are explained hereunder is to be understood that the invention, as fully described herein is not intended to be limited by the objects mentioned herein.

### SUMMARY OF INVENTION

Thus according to the basic aspect of the present invention there is provided a botanical pesticide for control of pests in agriculture and horticulture crops, comprising Adenanthera pavonina as the prime ingredient.

According to another aspect of the present invention there is provided a botanical pesticide, wherein the said botanical pesticide comprising essentially of:

Adenanthera pavonina;

Acorus calamus; and

Methanol,

wherein the ingredients are extracted using and/or through methanol.

It is another object of the present invention, wherein the percentage composition of Adenanthera pavonina and Acorus calamus is in the ratio of 80:20.

According to a further aspect of the present invention there is provided a botanical pesticide, wherein the said botanical pesticide comprising essentially of:

Adenanthera pavonina;

Alpine galanga; and

Methanol,

wherein the ingredients are extracted using and/or through methanol.

It is another aspect of the present invention, wherein the percentage composition of Adenanthera pavonina and Alpine galanga is in the ratio of 80:20.

In accordance with another aspect of the present invention, there is provided a botanical pesticide, wherein the said botanical pesticide comprising essentially of:

Adenanthera pavonina;

Euterpe precatoria;

Acontium heterophylum; and

Methanol,

wherein the ingredients are extracted using and/or through methanol.

It is another aspect of the present invention, wherein the percentage composition of Adenanthera pavonina, Euterpe precatoria, Acontium heterophylum and Methanol is in the ratio of 25:25:10:40.

In accordance with another aspect of the present invention, there is provided a botanical pesticide, wherein the said botanical pesticide comprising essentially of:

Adenanthera pavonina;

Euterpe precatoria;

Thevetia nerifolia; and

Methanol,

wherein the ingredients are extracted using and/or through methanol.

It is another aspect of the present invention, wherein the percentage composition of Adenanthera pavonina, Euterpe precatoria, Thevetia nerifolia and Methanol is in the ratio of 30:20:20:30.

In accordance with another aspect of the present invention, there is provided a botanical pesticide, wherein the said botanical pesticide comprising essentially of:

Adenanthera pavonina;

Aegle marmalus;

Solanum xanthocarbum; and

Methanol,

wherein the ingredients are extracted using and/or through methanol.

It is another aspect of the present invention, wherein the percentage composition of Adenanthera pavonina, Aegle marmalus, Solanum xanthocarbum and Methanol is in the ratio of 50:10:10:30.

It is another aspect of the present invention, wherein the prime ingredient Adenanthera pavonina exhibits synergism with other ingredients of the composition.

It is another aspect of the present invention, wherein the plant based chemicals including alkaloids, terpenes, glycolides are not isolated and used to take advantage of the intrinsic balance of bio chemicals of plants.

### DETAILED DESCRIPTION OF THE INVENTION

As stated above, the present invention provides very efficacious botanical pesticide, exhibiting synergism for agricultural and horticultural crops. The preferred efficacious pesticidal composition of the present invention maintains lower levels of chemicals and also maintains herbal balance without going in for actives which would lead to the classification of product as chemical pesticide again. The active ingredients of the present invention are substantially non-toxic to human and animals and it have minimal adverse effect on environment. Thus, the invention is eco friendly and environ safe.

Compared to the existing prior art, the pesticidal composition of the present invention controls pest at a lower dosage rate and have pesticidal activity against one or more pests.

The pesticidal composition of the present invention is advantageous in that it can immediately destroy up to 80% of pests occurred when the product is applied to Agriculture/Horticulture crops.

The product controls the target pests of cultivars that include:
Aphids
Mites
Jassids
Fulgorids
Mealy bugs
Tea mites—scarlet, purple, yellow, green and red
Thrips
Lace wing bugs
Leaf miners

The botanical pesticides according to the present invention essentially comprises of:

Adenanthera pavonina;

Acorus calamus; and

Alpine galangal

The prime ingredient Adenanthera pavonina exhibits synergism thereby helping the cultivars to protect agricultural and horticultural crops from pests. The plant based chemicals including alkaloids, terpenes, glycolides are not isolated and used to take advantage of the intrinsic balance of bio chemicals of plants. Moreover, the product maintains herbal balance without going in for actives which would lead to the classification of product as chemical pesticide again.

Advantageously, the product when applied to Agriculture/Horticulture crops results in upto 80% of immediate destroy of pests.

The foregoing examples illustrate different compositions of botanical pesticides with prime ingredient as Adenanthera pavonina and the process for preparing the same, wherein the combination exhibits synergism thus helping cultivars to protect from pests.

### EXAMPLE 1

| INGREDIENTS | COMPOSITION |
|---|---|
| Adenanthera pavonina | 80% (alcohol saturated extract) |
| Acorus calamus | 20% (alcohol saturated extract) |
| Methanol | Required for extraction |

Wherein the process for preparing the said product comprises the steps of:

1. Adenanthera pavonina is extracted through methanol in Soxhlet apparatus.

2. Acorus calamus is extracted through methanol in Soxhlet apparatus.

3. The extracts are then mixed as per said % composition.

### EXAMPLE 2

| INGREDIENTS | COMPOSITION |
|---|---|
| Adenanthera pavonina | 80% (alcohol saturated extract) |
| Alpine galanga | 20% (alcohol saturated extract) |
| Methanol | Required for extraction |

Wherein the process for preparing the said product comprises the steps of:

1. Adenanthera pavonina is extracted through methanol in Soxhlet apparatus.

2. Alpine galanga is extracted through methanol in Soxhlet apparatus.

3. The extracts are then mixed as per said % composition.

### EXAMPLE 3

| INGREDIENTS | COMPOSITION |
|---|---|
| Adenanthera pavonina | 25% |
| Euterpe precatoria | 25% |
| Acontium heterophylum | 10% |
| Methanol | 40% |

Wherein the process for preparing the said product comprises the steps of:

1. Adenanthera pavonina is extracted through methanol in Soxhlet apparatus.

2. Euterpe precatoria is extracted through methanol in Soxhlet apparatus.

3. Acontium heterophylum is extracted through methanol in Soxhlet apparatus

4. The extracts are then mixed as per said % composition.

### EXAMPLE 4

| INGREDIENTS | COMPOSITION |
|---|---|
| Adenanthera pavonina | 30% |
| Euterpe precatoria | 20% |
| Thevetia nerifolia | 20% |
| Methanol | 30% |

Wherein the process for preparing the said product comprises the steps of:

1. Adenanthera pavonina is extracted through methanol in Soxhlet apparatus.

2. Euterpe precatoria is extracted through methanol in Soxhlet apparatus.

3. Thevetia nerifolia is extracted through methanol in Soxhlet apparatus

4. The extracts are then mixed as per said % composition.

### EXAMPLE 5

| INGREDIENTS | COMPOSITION |
|---|---|
| Adenanthera pavonina | 50% |
| Aegle marmalus | 10% |
| Solanum xanthocarbum | 10% |
| Methanol | 30% |

Wherein the process for preparing the said product comprises the steps of:

1. Adenanthera pavonina is extracted through methanol in Soxhlet apparatus.

2. Aegle marmalus is extracted through methanol in Soxhlet apparatus.

3. Solanum xanthocarbum is extracted through methanol in Soxhlet apparatus

4. The extracts are then mixed as per said % composition.

The above examples provide representations of the effectiveness of some preferred compositions within the scope of the present invention. The present invention may be embodied in other specific forms without departing from its spirit or essential characteristics. The described embodiments are to be considered in all respects only as illustrative and not restrictive.

We claim:

1. A botanical pesticide for control of pests in agriculture and horticulture crops, comprising Adenanthera pavonina as the prime ingredient.

2. The botanical pesticide as claimed in claim 1, wherein the said botanical pesticide comprising essentially of:
Adenanthera pavonina;
Acorus calamus; and
Methanol,
wherein the ingredients are extracted using and/or through methanol.

3. The botanical pesticide as claimed in claim 2, wherein the percentage composition of Adenanthera pavonina and Acorus calamus is in the ratio of 80:20.

4. The botanical pesticide as claimed in claim 1, wherein the said botanical pesticide comprising essentially of:
Adenanthera pavonina;
Alpine galanga; and
Methanol,
wherein the ingredients are extracted using and/or through methanol.

5. The botanical pesticide as claimed in claim 4, wherein the percentage composition of Adenanthera pavonina and Alpine galanga is in the ratio of 80:20.

6. The botanical pesticide as claimed in claim 1, wherein the said botanical pesticide comprising essentially of:
Adenanthera pavonina;
Euterpe precatoria;
Acontium heterophylum; and
Methanol,
wherein the ingredients are extracted using and/or through methanol.

7. The botanical pesticide as claimed in claim 6, wherein the percentage composition of Adenanthera pavonina, Euterpe precatoria, Acontium heterophylum and Methanol is in the ratio of 25:25:10:40.

8. The botanical pesticide as claimed in claim 1, wherein the said botanical pesticide comprising essentially of:
Adenanthera pavonina;
Euterpe precatoria;
Thevetia nerifolia; and
Methanol,
wherein the ingredients are extracted using and/or through methanol.

9. The botanical pesticide as claimed in claim 8, wherein the percentage composition of Adenanthera pavonina, Euterpe precatoria, Thevetia nerifolia and Methanol is in the ratio of 30:20:20:30.

10. The botanical pesticide as claimed in claim 1, wherein the said botanical pesticide comprising essentially of:
Adenanthera pavonina;
Aegle marmalus;
Solanum xanthocarbum; and
Methanol,
wherein the ingredients are extracted using and/or through methanol.

11. The botanical pesticide as claimed in claim 10, wherein the percentage composition of Adenanthera pavonina, Aegle marmalus, Solanum xanthocarbum and Methanol is in the ratio of 50:10:10:30.

12. The botanical pesticide as claimed in anyone of claim 11, wherein the prime ingredient Adenanthera pavonina exhibits synergism with other ingredients of the composition.

13. The botanical pesticide as claimed in anyone of claim 12, wherein the plant based chemicals including alkaloids, terpenes, glycolides are not isolated and used to take advantage of the intrinsic balance of bio chemicals of plants.
